(19) United States
(12) Patent Application Publication
(10) Pub. No.: US 2020/0177066 A9
(43) Pub. Date: Jun. 4, 2020

(54) POWER GENERATION APPARATUS AND AQUARIUM EQUIPMENT

(71) Applicant: GUANGDONG BOYU GROUP CO., LTD, Chaozhou City (CN)

(72) Inventors: Youkai YU, Chaozhou City (CN); Bingyan YU, Chaozhou City (CN); Jianqin YU, Chaozhou City (CN)

(21) Appl. No.: 16/268,572

(22) Filed: Feb. 6, 2019

(30) Foreign Application Priority Data
Feb. 6, 2018 (CN) 201820213891.2
Mar. 26, 2018 (CN) 201820412462.8

(51) Int. Cl. H02K 17/44; H02K 5/132; H02K 11/33; A01K 63/06; A01K 63/04; F04D 13/08

(52) U.S. Cl. CPC H02K 17/44; H02K 5/132; H02K 11/33; F04D 13/086; A01K 63/045; A01K 63/047; A01K 63/06

(57) ABSTRACT

Provided are a power generation apparatus and an aquarium equipment. The power generation apparatus includes a water pump and a magnetic induction generator. The water pump includes a housing, a stator mounted in the housing, a first rotor assembly, and an impeller connected to the first rotor assembly. The first rotor assembly includes a first permanent magnet rotor and a first rotating shaft disposed at an axis of the first permanent magnet rotor. The first permanent magnet rotor is disposed adjacent to the stator. The magnetic induction generator is disposed adjacent to the stator or to the first permanent magnet rotor and is operative to be coupled to an electric device. The stator includes a coil winding operative to be coupled to an external power source, so that when the coil winding is coupled to an input alternating current, the first permanent magnet rotor rotates enabling the magnetic induction generator to generate an induced current to power up the electric device. The aquarium equipment includes the power generation apparatus described above.

### CROSS-REFERENCES TO RELATED APPLICATIONS

This application claims priority to Chinese patent application No. 201820213891.2 filed on Feb. 6, 2018, and Chinese patent application No. 201820412462.8 filed on Mar. 26, 2018, disclosures of which are incorporated herein by reference in their entireties.

### TECHNICAL FIELD

The present disclosure relates to the technical field of aquarium devices, and, more particularly, to a power generation apparatus and an aquarium equipment.

### BACKGROUND

A water pump is usually mounted in an aquarium for pumping water. The water pump includes a housing, which includes a pump housing, a stator chamber, and a rotor chamber. An impeller is mounted in the pump housing. A stator is mounted in the stator chamber. A permanent magnet rotor is mounted in the rotor chamber. The permanent magnet rotor is fixedly connected to the impeller by a rotating shaft or is directly fixedly connected to the impeller. The rotating shaft is arranged at an axis of the permanent magnet rotor. The stator, after energized, drives the permanent magnet rotor to rotate, thereby driving the impeller to rotate and further achieving the purpose of pumping water under the action of the pump housing.

However, the above-mentioned water pump only serves the function of pumping water, and other low-power electric devices such as a lamp in the aquarium need to be supplied power independently. Mainly there are two ways of supplying power thereto. The first one is connecting the electric devices to an external power source by a conductive wire. The second one is supplying power to the electric device by a battery. When the first power supply method is adopted, the electrical connections of the electric devices would need to be disconnected before disassembling or assembling the water pump, which adversely affects the disassembly and assembly efficiency of the water pump. When the second power supply method is adopted, the battery needs to be replaced when it runs out of power, which is troublesome.

### SUMMARY

An object of the present disclosure is therefore to provide a power generation apparatus, which can achieve the purpose of supplying power to an electric device while pumping water at the same time.

Another object of the present disclosure is to provide an aquarium equipment, whereby an independent power supply device is not needed to power up the electric device, and so the electrical connection of the electric device can be directly cut off when the electric device is removed.

To achieve these objects, the present disclosure adopts the following technical solutions.

There is provided power generation apparatus includes a water pump and a magnetic induction generator.

The water pump includes a stator, a first rotor assembly, and an impeller connected to the first rotor assembly. The first rotor assembly includes a first permanent magnet rotor and a first rotating shaft disposed at an axis of the first permanent magnet rotor. The first permanent magnet rotor is disposed adjacent to the stator.

The magnetic induction generator is disposed adjacent to the stator or to the first permanent magnet rotor and is operative to be coupled to an electric device. The stator may comprise a coil winding operative to be coupled to an external power source. When the coil winding is coupled to an input alternating current, the first permanent magnet rotor is configured to rotate enabling the magnetic induction generator to generate an induced current to power up the electric device.

Typically, the magnetic induction generator includes a second rotor assembly and a power generation induction coil.

The second rotor assembly includes a second permanent magnet rotor and a second rotating shaft disposed at an axis of the second permanent magnet rotor. The power generation induction coil is wound around an exterior of the second permanent magnet rotor, and when the coil winding is coupled to the input alternating current, the second permanent magnet rotor is operative to rotate relative to the power generation induction coil.

Typically, an axis of the second rotating shaft and an axis of the first rotating shaft forms an included angle that lies in the range of 0° to 15°.

Typically, the second rotating shaft runs parallel to the first rotating shaft.

Typically, the magnetic induction generator further includes a reel disposed outside the second permanent magnet rotor. The second permanent magnet rotor being clearance-fitted to the reel. The power generation induction coil is wound around the reel along the axis of the second permanent magnet rotor. Both end of the reel that reside along a length thereof are each provided with a rotating shaft seat. The second rotating shaft passes through the reel to be connected to the rotating shaft seat.

Typically, the power generation induction coil includes a first power generation induction coil and a second power generation induction coil spaced apart and coupled to each other. The first power generation induction coil and the second power generation induction coil are symmetrically arranged at two sides on a circumference of the second permanent magnet rotor.

Typically, the water pump further includes a housing. The stator, the first rotor assembly, and the impeller are all arranged in the housing.

Typically, the housing defines a mounting slot at a location adjacent to the first permanent magnet rotor, and the magnetic induction generator is detachably mounted in the first mounting slot.

Typically, the power generation apparatus further includes a mounting box in which the magnetic induction generator is detachably mounted, where the mounting box is detachably mounted in the first mounting slot, and the power generation induction coil comprises a lead wire that passes through the mounting box to be coupled to the electric device.

Typically, the mounting box includes a box body having an open end and a cover body configured to cover the open end. A positioning step is provided on an inner wall of the box body that directly faces the open end. A plurality of positioning columns are provided at intervals on a side of the cover body adjacent to the box body. When the cover body covers the open end, both sides of the reel abut against the positioning step and the plurality of positioning columns, respectively.

Typically, the box body is provided with a mounting hole located adjacent to the open end and an admission hole in communication with the mounting hole. The admission hole has a smaller size than that of the mounting hole. The positioning step is formed between the admission hole and the mounting hole.

The cover body is provided with at least two of the positioning columns disposed at intervals. An admission area is formed between two positioning columns. The magnetic induction generator is mounted in the mounting hole. One end of the second rotating shaft extends into the admission hole, and the other end extends into the admission area.

Typically, the electric device includes a first lamp disposed outside the housing adjacent to the magnetic induction generator.

There is further provided aquarium equipment that includes the power generation apparatus described above.

Typically, the aquarium equipment is an aquarium in which the water pump further includes a pump housing and the impeller is mounted in the pump housing.

The first rotor assembly, the pump housing, and the impeller are mounted in a tank of the aquarium. The stator is mounted outside the tank.

A U-shaped iron core of the stator comprises two iron core protrusion portions that protrude out of the coil winding of the stator, an outer wall of the tank is recessed to define a stator receiving chamber that faces towards the tank, which includes two first receiving chambers spaced apart from each other. The iron core protrusion portions are disposed in the first receiving chambers. A receiving slot is defined in an inner wall of the tank and between the two first receiving chambers. The impeller fixedly connected to the first permanent magnet rotor in the receiving slot by the first rotating shaft, and the magnetic induction generator is disposed inside the tank adjacent to the stator of the first permanent magnet rotor.

Typically, the electric device includes a second lamp. A filter is detachably mounted in the tank and disposed at a bottom of the tank. The second lamp is mounted on the filter, the pump housing is detachably fixed to a lower end of the filter, and the stator receiving chamber is located at the bottom of the tank.

Typically, the water pump further includes a mounting base connected to the pump housing, the mounting base being disposed in the receiving slot. The first rotor assembly is mounted in mounting base. The magnetic induction generator is mounted in a sealing box, which is disposed at a side of the mounting base adjacent to the filter. A bottom of the filter is recessed to define a second mounting slot that faces towards the filter, and the sealing box and the pump housing are inserted and fixed to the second mounting slot.

Typically, the pump housing includes a pump housing body and a pump housing cover detachably connected to each other, the pump housing cover defines a water inlet, a side wall of the pump housing body away from the pump housing cover defines a through hole, the first rotating shaft passes through the through hole from a side of the mounting base to be connected to the impeller in the pump housing body, and an upper end of the pump housing is provided with a water outlet communicated to a drain pipe.

Typically, the aquarium equipment further includes a base. The stator is fixed to the base. The tank is detachably mounted on the base.

Typically, the aquarium equipment further includes a drive circuit configured to provide a low-voltage direct current power source and a voltage change and to control turning on and off of the electric device.

The present disclosure provides the following beneficial effects:

When an alternating current is input to the coil winding of the stator, an alternating magnetic field is generated causing the first permanent magnet rotor to rotate and drive the impeller to rotate and thus generate a centrifugal force to achieve purpose of pumping water. Since certain leakage magnetic field would be generated in the surroundings of the first permanent magnet rotor and the stator, these leakage magnetic fields can be utilized to enable the magnetic induction generator to generate an induced current that is to be used to power up the electric device (a low-power device) in the aquarium equipment. Thus, safety hazards such as electric leakage which may occur when the electric device is powered by using the power supply device alone can be avoided. In this disclosure, the power generation apparatus combines the water pump with the magnetic induction generator, so as to realize the purpose of powering up the electric device while pumping water at the same time. Compared with the related art, the operations in terms of supplying power to the electric device as well as turning on and off the electrical connection of the electric device are rendered more convenient.

### BRIEF DESCRIPTION OF DRAWINGS

FIG. 1 is a perspective view of a power generation apparatus according to Embodiment one of the present disclosure;

FIG. 1 is a schematic view illustrating the mounting relationships between a magnetic induction generator and a water pump excluding a housing according to Embodiment one of the present disclosure;

FIG. 3 is a partial exploded view of the power generation apparatus according to Embodiment one of the present disclosure;

FIG. 4 is an exploded view of a magnetic induction generator and a mounting box according to Embodiment one of the present disclosure;

FIG. 5 is a cross-sectional view in which a magnetic induction generator is mounted in a mounting box according to Embodiment one of the present disclosure;

FIG. 6 is a perspective view of an aquarium equipment according to Embodiment two of the present disclosure;

FIG. 7 is a cross-sectional view of an aquarium equipment according to Embodiment two of the present disclosure;

FIG. 8 is an exploded view of a first perspective of an aquarium equipment according to Embodiment two of the present disclosure;

FIG. 9 is an exploded view of a second perspective of an aquarium equipment according to Embodiment two of the present disclosure; and

FIG. 10 is an exploded view of a magnetic induction generator and a water pump (excluding a stator) of an aquarium equipment according to Embodiment two of the present disclosure.

In the drawings:
1. Water Pump;
11. Stator; 111. U-shaped Iron Core; 112. Coil Winding; 113. Notch;
12. First Rotor Assembly; 121. First Permanent Magnet Rotor; 122. First Rotating Shaft;
13. Impeller;
2. Magnetic Induction Generator;
21. Second Permanent Magnet Rotor;
22. Second Rotating Shaft;
23. Power Generation Induction Coil;
24. Reel;

In embodiment one:
100. Housing; 101. First Mounting Slot; 102. Suction Plate; 103. First lamp;
200. Power Cable;
300. Mounting Box; 310. Box body; 311. Mounting Hole; 312. Admission Hole; 320. Cover body; 321. Positioning Column;

In embodiment two:
400. Tank; 410. Stator Receiving Chamber; 411. First receiving Chamber; 412. Second Receiving Chamber; 420. Receiving Slot;
500. Pump Housing; 501. Pump Housing Body; 502. Pump Housing Cover; 503. Water Inlet; 504. Water Outlet;
600. Mounting Base;
700. Filter; 701. Second Lamp;
800. Sealing Box; 801. Box Body; 802. Box Cover;
900. Base; 901. Stator Isolation Chamber; 902. Wire securing clip.

### DETAILED DESCRIPTION

Embodiments in accordance with the present disclosure will now be described in detail below. Examples of the embodiments are illustrated in the drawings, where the same or similar reference numerals indicate the same or similar elements or elements having the same or similar functions. The embodiments described below with reference to the drawings are merely exemplary; they are intended to explain the present disclosure, and are not to be construed as limiting the present disclosure.

In the description of the present disclosure, it should be understood that the orientational or positional relationships indicated by terms “inside”, “outside” and the like are based on the orientational or positional relationships illustrated in the drawings, which are for the mere purpose of facilitating and simplifying the description of the present disclosure, and these relationships do not indicate or imply that the device or element referred to has a specific orientation and is constructed and operated in a specific orientation, and thus it is not to be construed as limiting the present disclosure.

Furthermore, terms like “first” and “second” are for description only and are not to be construed as indicating or implying relative importance or implicitly indicating the number of technical features as indicated. Thus, a feature defined as a “first” feature or a “second” feature may explicitly or implicitly include one or more of such a feature.

Unless otherwise expressly specified and defined, the term “fixed” is to be construed in a broad sense; for example, it is to be interpreted as permanently coupled, detachably coupled, or integrated; mechanically coupled or electrically coupled; directly coupled to each other or indirectly coupled to each other via an intermediary; or internally coupled or interactional between two components. For those of ordinary skill in the art, the above terms can be construed depending on specific contexts.

The technical solutions in accordance with the present disclosure will now be further described below by means of specific embodiments in conjunction with the drawings.

### Embodiment One

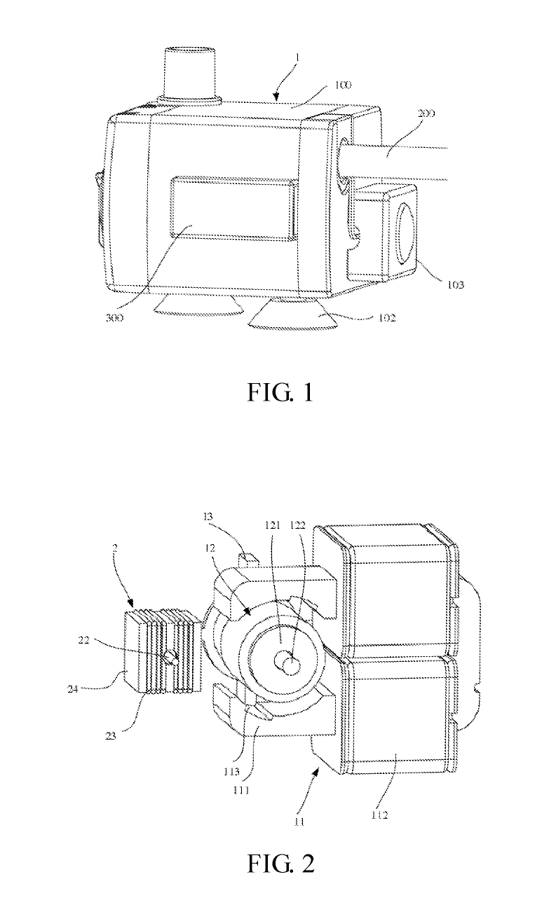

As illustrated in FIGS. 1 to 5, embodiment one of the present disclosure provides a power generation apparatus, which includes a water pump 1 and a magnetic induction generator 2. The water pump 1 includes a housing 100 and a stator 11 mounted in the housing 100, a first rotor assembly 12, and an impeller 13 connected to the first rotor assembly 12. The first rotor assembly 12 includes a first permanent magnet rotor 121 and a first rotating shaft 122 disposed at an axis of the first permanent magnet rotor 121. The first permanent magnet rotor 121 is disposed adjacent to the stator 11. The magnetic induction generator 2 is disposed adjacent to the stator 11 or the first permanent magnet rotor 121 and is operative to be coupled to an electric device. The stator 11 includes a coil winding operative to be coupled to an external power source, and when the coil winding 112 is coupled to an input alternating current, the first permanent magnet rotor 121 is configured to rotate enabling the magnetic induction generator 2 to generate an induced current to power up the electric device. By arranging the magnetic induction generator 2 adjacent to the stator 11 or to the first permanent magnet rotor 121, an alternating magnetic field would be generated when the alternating current is input into the coil winding 12 of the stator 11, so that the first permanent magnet rotor 121 rotates about the stator 11. Meanwhile, since a certain leakage magnetic field would be generated in the surroundings of the first permanent magnet rotor 121 and the stator 11, these leakage magnetic fields can be utilized to enable the magnetic induction generator 2 to generate the induced current that is to be used to power up the electric device (a low-power device), thereby avoiding safety hazards such as electric leakage which may occur when the electric device in the tank is powered up by using the power supply device alone.

The power generation apparatus in the present disclosure combines the water pump 1 with the magnetic induction generator 2, so as to realize the purpose of powering up the electric device while pumping water at the same time. Compared with the related art, operations in terms of supplying power to the electric device as well as turning on and off the electrical connection of the electric device are rendered more convenient.

In this embodiment, a via hole is defined the housing 100 of the water pump 1 and configured for a power cable 200 to pass through. One end of the power cable 200 is coupled to the coil winding 112 of the stator 11, and the other end is coupled to an external power source base.

In this embodiment, as illustrated in FIG. 2, the stator 11 includes a U-shaped iron core 111 and the coil winding 112 disposed around the U-shaped iron core 111. The U-shaped iron core 111 includes two iron core protrusion portions that protrude out of the coil winding 112. The first rotor assembly 12 is disposed between the two iron core protrusion portions, an inner side of each one of the two iron core protrusion portions is provided with a starting angle notch 113. When the alternating current is input into the coil winding 112 of the stator 11, the alternating magnetic field is generated. The alternating magnetic field is transmitted to the notch 113 (the starting angle) along the U-shaped iron core 111 (the silicon steel sheet). Since the presence of the notch 113 renders the generated magnetic field to be uneven, the first permanent magnet rotor 121 of the water pump 1 would set into rotation.

The electric device in this embodiment is the low-power device. Experiments prove that it is totally feasible to supply power to other low-power electric devices with this power supply method of the embodiment.

The magnetic induction generator 2 includes a second rotor assembly and a power generation induction coil 23. The second rotor assembly includes a second permanent magnet rotor 21 and a second rotating shaft 22 disposed at an axis of the second permanent magnet rotor 21, the power generation induction coil 23 is wound around an exterior of the second permanent magnet rotor 21. When the coil winding 112 is coupled to the alternating current, the second permanent magnet rotor 21 is operative to rotate relative to the power generation induction coil 23, thereby generating the induced current.

An axis of the second rotating shaft 22 and an axis of the first rotating shaft 122 may form an included angle that lies in the range of 0° to 15°. That is, the second rotating shaft 22 may run parallel to the first rotating shaft 122, or the two may run almost parallel to each other, so that the magnetic flux density of the alternating magnetic field passing through the power generation induction coil 23 can be relatively large, thereby generating a induced current that is large enough to power up the electric device.

Typically, the second rotating shaft 22 runs parallel to the first rotating shaft 122, so that the magnetic flux density of the alternating magnetic field passing through the power generation induction coil 23 can be largest.

In this embodiment, the magnetic induction generator 2 further includes a reel 24 disposed outside the second permanent magnet rotor 21. The second permanent magnet rotor 21 may be clearance-fitted to the reel 24. The power generation induction coil 23 is wound around on the reel 24 along an axis of the second permanent magnet rotor 21. Both ends of the reel 24 that reside along a length thereof are each provided with a rotating shaft seat. The second rotating shaft 22 passes through the reel 24 and to be connected to the rotating shaft seat. The power generation induction coil 23 is fixed to the second permanent magnet rotor 21 by the reel 24.

Furthermore, the power generation induction coil 23 includes a first power generation induction coil and a second power generation induction coil spaced apart from and coupled to each other. The first power generation induction coil and the second power generation induction coil are symmetrically arranged at two sides on a circumference of the second permanent magnet rotor 21, which may improve the power supply efficiency and power generation efficiency of the power generation induction coil 23.

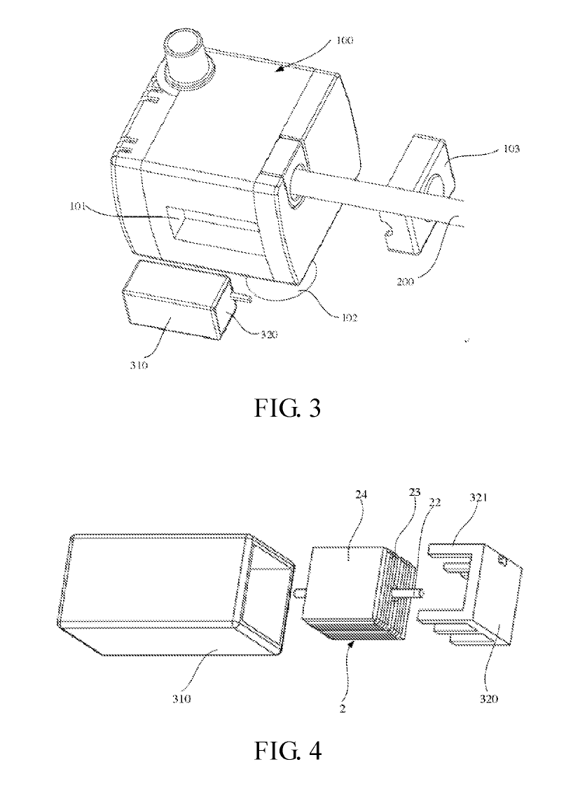

In this embodiment, the magnetic induction generator 2 is disposed outside the housing 100 of the water pump 1, which facilitates the mounting of the magnetic induction generator 2. Specifically, as illustrated in FIG. 3, a first mounting slot 101 is provided in the housing 100 at a location adjacent to the first permanent magnet rotor 121, and the magnetic induction generator 2 is detachably mounted in the first mounting slot 101.

The power generation apparatus further includes a mounting box 300. The magnetic induction generator 2 is detachably mounted in the mounting box 300. The mounting box 300 is detachably mounted in the first mounting slot 101, and a lead wire of the power generation induction coil 23 passes through the mounting box 300 to be connected to the electric device. The mounting box 300 is clamped and fixed in the first mounting slot 101, which facilitates the disassembling or assembling of the mounting box.

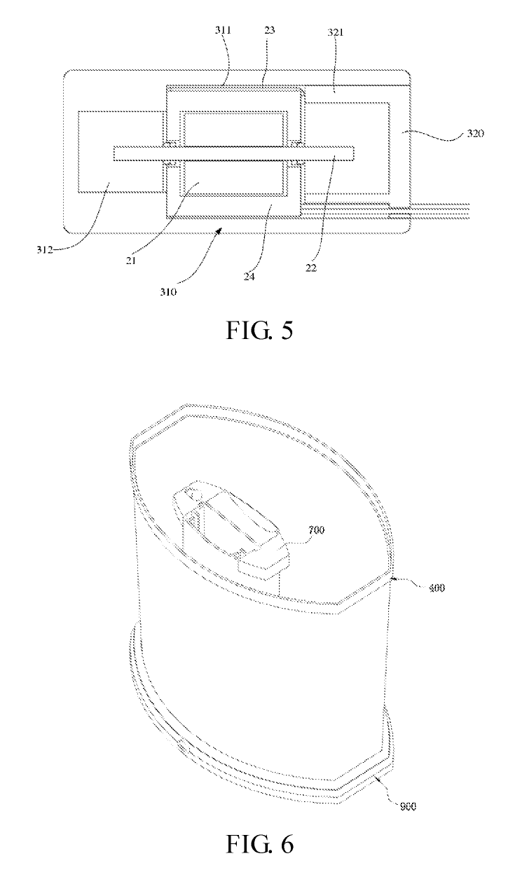

In this embodiment, as illustrated in FIGS. 4 and 5, the mounting box 300 includes a box body 310 having an open end and a cover body 320 configured to cover the open end, a positioning step is provided on an inner wall of the box body 310 that directly faces the open end, a plurality of positioning columns 321 are provided at intervals on a side of the cover body 320 adjacent to the box body 310, and when the cover body 320 covers the open end, both sides of the reel 24 abuts against the positioning step and the plurality of positioning columns 321, respectively, so that the reel and the power generation induction coil 23 are secured in the mounting box 300. Thus, the second rotating shaft 22 and the second permanent magnet rotor 21 may rotate relative to the reel 24 and the power generation induction coil 23, enabling the power generation induction coil 23 to generate the induced current.

Furthermore, the box body 310 is provided with a mounting hole 311 located adjacent to the open end and an admission hole 312 in communication with the mounting hole 311. The admission hole 312 has a smaller size than that of the mounting hole 311. The positioning step is formed between the admission hole 312 and the mounting hole 311.

The cover body 320 is provided with at least two of the positioning columns 321 disposed at intervals, and an admission area is formed between the two positioning columns 321. The magnetic induction generator 2 is mounted in the mounting hole 311, one end of the second rotating shaft 22 extends into the admission hole 312, and the other end extends into the admission area.

With the above structural design, the second rotating shaft 22 can be prevented from coming into contact with components other than the rotating shaft seat which may otherwise adversely affect the rotation of the second rotating shaft 22.

Of course, the magnetic induction generator 2 in this embodiment will not be limited to being mounted on the housing 100 of the water pump by means of the mounting box 300, the magnetic induction generator 2 may also be mounted on the housing 100 by means of directly perfusing an insulating material such as epoxy resin.

To facilitate the fixing the power generation apparatus to the aquarium equipment such as an aquarium, an outer side of one of the side walls of the housing 100 may be provided with multiple suction plates 102 arranged at intervals. The power generation apparatus can be selectively fixed to the aquarium by the suction plates 102.

The housing 100 is provided with a water inlet and a water outlet. The multiple suction plates 102 are disposed at intervals on an outer side of a side wall of the housing 100 where the water inlet or the water outlet is not arranged.

In this embodiment, the electric device includes a first lamp 103 arranged outside the housing 100 adjacent to the magnetic induction generator 2. Specifically, the first lamp 103 may be disposed at a side of the cover body away from the box body 310. The cover body 320 and the housing 100 may be respectively provided with a through hole configured for a lead wire of the power generation induction coil 23 to pass through. After passing through the through hole, the lead wire of the power generation induction coil 23 is coupled to the first lamp 103.

Furthermore, the first lamp 103 may include a light emitting diode (LED) and a sealing cover that seals and mounts the LED onto the housing 100, enabling the first lamp 103 to have a desirable waterproof functionality. The sealing cover may be provided with a light-transmitting region configured for the light of the LED is to be transmitted through.

The other embodiments differ from the above embodiment in that: the coil winding 112 is disposed adjacent to both ends of the U-shaped iron core 111 along a length thereof. The first permanent magnet rotor 121 is disposed outside the stator 11. The coil winding 112 may also be coupled to the alternating current so that the magnetic induction generator 2 is operative to generate the induced current.

Furthermore, two end surfaces of the U-shaped iron core 111 along the length may be flush with a side surface of the coil winding 112 adjacent to the first rotor assembly 12.

Embodiments of the present disclosure further provide an aquarium equipment, which includes the above power generation apparatus. The power generation apparatus may be directly disposed on the aquarium equipment such as an aquarium, a filter or a protein skimmer.

### Embodiment Two

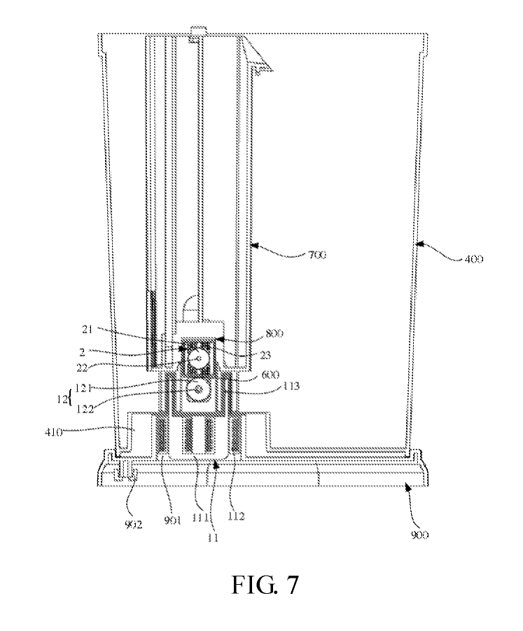

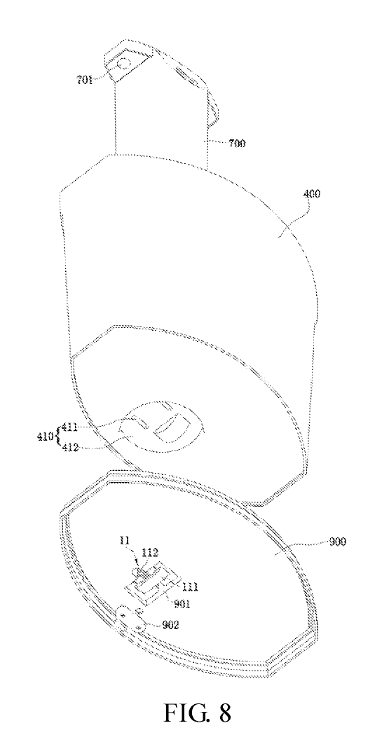

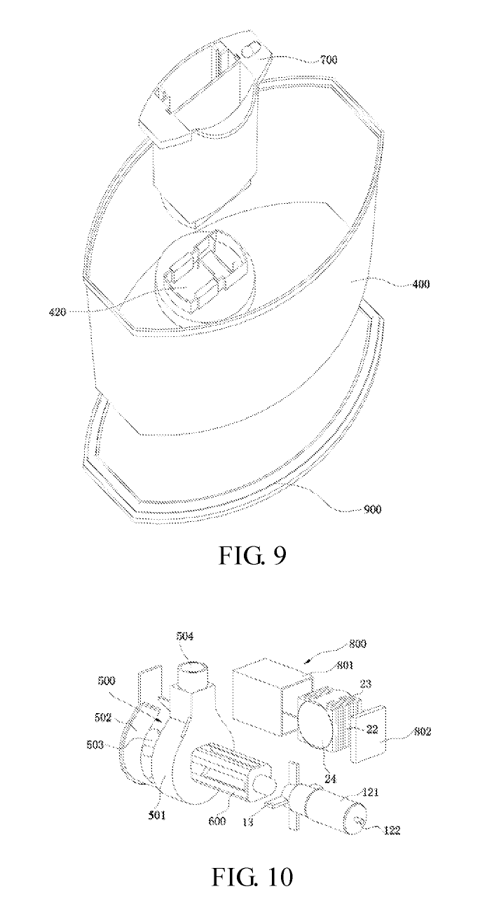

As illustrated in FIGS. 6 to 10, the embodiment two of the present disclosure provides an aquarium equipment. The aquarium equipment may be an aquarium, a filter or a protein skimmer. When the aquarium equipment is an aquarium, it includes a tank 400, a water pump 1, a magnetic induction generator 2, and an electric device disposed in the tank 400 and coupled to the magnetic induction generator 2. The water pump 1 includes a first rotor assembly 12 and a pump housing 500, mounted in the tank, an impeller 13 disposed in the pump housing 500, and a stator 11 mounted outside the tank 400. A U-shaped iron core 111 of the stator 11 has two iron core protrusion portions that protrude out of a coil winding 112. An outer wall of the tank 400 is recessed to define a stator receiving chamber 410 that faces towards the tank, which includes two first receiving chambers 411 spaced apart from each other. The iron core protrusion portions are arranged in the first receiving chambers 411, and a receiving slot 420 is defined in an inner wall of the tank 400 and between the two first receiving chambers 411. The first rotor assembly 12 includes a first rotating shaft 122 and a first permanent magnet rotor 121. The impeller 13 is secured to the first permanent magnet rotor 121 disposed in the receiving slot 420 by the first rotating shaft 122. The magnetic induction generator 2 is disposed inside the tank 400 adjacent to the stator 11 or the first permanent magnet rotor 121. The U-shaped iron core 111 (a silicon steel sheet) of the stator 11 has two iron core protrusion portions that protrude out of a coil winding 112 thereof, and in an inner side of each one of the two iron core protrusion portions is defined a notch 113. Each notch 113 is provided with a sloping surface. The two notches 113 are disposed up and down and spaced apart from each other, and the sloping surface of one notch 113 is inclined upwards, the sloping surface of the other notch 113 is inclined downwards. When an alternating current is input into the coil winding 112 of the stator 11, an alternating magnetic field is generated. The alternating magnetic field is transmitted to the notch 113 (a starting angle) along the U-shaped iron core 111 (the silicon steel sheet). Due to the presence of the notch 113, the generated magnetic field would be rendered uneven so that the first permanent magnet rotor 121 of the water pump 1 would rotate. Then, the first permanent magnet rotor 121 drives the impeller 12 to rotate thereby generating a centrifugal force. Under the action of the pump housing 500, water flows from a water inlet 503 to a water outlet 504, thus realizing the purpose of water pumping of the water pump 1. Meanwhile, a certain leakage magnetic field would be generated in the surroundings of the stator 11 of the water pump 1. This leakage magnetic field can be utilized to enable the magnetic induction generator to generate an induced current that can then be used to power up the electric device (a low-power device) in the aquarium.

As illustrated in FIG. 2, in this embodiment the notch 113 has two surfaces, one of which is the sloping surface as described above, while the other is a plane that runs parallel to the bottom of the stator 11. This plane and the sloping surface form an angle called the starting angle that is configured for starting the rotation of the first permanent magnet rotor 121.

Compared with the related art, this embodiment can avoid safety hazards such as electric leakage which may occur when the electric device in the tank is powered up by using the power supply device independently.

In this embodiment, the electric devices in the tank 400 are all low-power devices. Experiments have proved that it is perfectly feasible to power up other low-power electric devices with this power supply mode in accordance with the embodiment as long as the water pump has a large enough power.

As illustrated in FIG. 4, a side of the bottom of the tank 400 adjacent to the inside of the tank 400 is provided with an inserting part connected to an outer wall of the first receiving chamber 411. The inserting part is connected to the outer wall of the first receiving chamber 411 to form a recess. The recess includes the receiving slot 420 and a second mounting slot for mounting the pump housing 500. An outer wall of the inserting part is inserted and fitted with a lower end part of the filter 700. Further a waterproof part is annularly disposed outside outer wall of the inserting part and the first receiving chamber 411, the waterproof part is disposed at an outer side of the lower end part of the filter 700.

Specifically, as illustrated in FIGS. 1 and 5, the magnetic induction generator 2 includes a second rotor assembly and a power generation induction coil 23. The second rotor assembly includes a second permanent magnet rotor 21 and a second rotating shaft 22 located at an axis of the second permanent magnet rotor 21. The power generation induction coil 23 is would around an exterior of the second permanent magnet rotor 21. The second rotating shaft is disposed in the tank 400. The second rotating shaft is inserted and fitted with a shaft hole of the second permanent magnet rotor 21. The second permanent magnet rotor 21 is operative to rotate about the second rotating shaft 22. An axis of the second rotating shaft 22 and an axis of the first rotating shaft 122 forms an included angle that lies in the range of 0° to 15°. That is, the second rotating shaft 22 is parallel to the first rotating shaft 122, or the two are approximately parallel to each other, so that the magnetic flux density of the alternating magnetic field passing through the power generation induction coil 23 can be relatively large, thereby generating an induced current that is large enough to power up the electric device.

Typically, as illustrated in FIG. 2, the second rotating shaft 22 is parallel to the first rotating shaft 122, so that the magnetic flux density of the alternating magnetic field passing through the power generation induction coil 23 can be the highest.

In this embodiment, the magnetic induction generator 2 further includes a reel 24 disposed outside the second permanent magnet rotor 21. The reel 24 has a rotor chamber, and the second permanent magnet rotor 21 is mounted in the rotor chamber and clearance fitted with the reel 24. The power generation induction coil 23 is wound around the reel 24 along an axis of the second permanent magnet rotor 21. Each end of the reel 24 along a length thereof is provided with a rotating shaft seat. The second rotating shaft 22 passes through the reel 24 and is connected to the rotating shaft seat. The power generation induction coil 23 is fixed to the second permanent magnet rotor 21 by the reel 24.

Furthermore, the power generation induction coil 23 includes a first power generation induction coil and a second power generation induction coil disposed at intervals and coupled to each other. The first power generation induction coil and the second power generation induction coil are symmetrically disposed at two sides along a circumference of the second permanent magnet rotor 21, which can improve the power supply efficiency and the power generation efficiency of the power generation induction coil 23.

In this embodiment, the electric device includes a second lamp 701. The filter 700 is detachably mounted inside the tank 400 at a bottom thereof. The second lamp 701 is mounted on the filter 700. The pump housing 500 is detachably fixed to a lower end of the filter 700. Correspondingly, the stator receiving chamber 410 is disposed at the bottom of the tank 400. When cleaning the filter 700, the filter 700, the first rotor assembly 12 as well as the impeller 13 can be moved outside the tank 400 and cleaned altogether. Because it is not needed to power off the second lamp 701 before the removal, this facilitates the cleaning and maintenance of the aquarium. Specifically, the filter 700 is inserted and fixed to an outer side wall of the first receiving chamber 411 that protrudes within the tank 400, which facilitates the disassembling or assembling of the filter 700. When the filter 700 mounted with the first rotor assembly 12 and the impeller 13 of the water pump 1 is inserted into the tank 400, the first rotor assembly 12 is then located between the two first receiving chambers 411. As illustrated in FIG. 5, the water pump 1 further includes a mounting base 600 connected to the pump housing 500. The mounting base 600 is located in the receiving slot 420. The first rotor assembly 12 is mounted in the mounting base 600. The magnetic induction generator 2 is mounted in a sealing box 800 which is located at a side of the mounting base adjacent to the filter 700. A bottom of the filter 700 is recessed to define a second mounting slot that faces towards the filter. The sealing box 800 and the pump housing 500 are inserted and fixed to the second mounting slot, thereby achieving a detachable connection between the water pump 1 and the filter 700.

Specifically, the sealing box 800 includes a box body 801 and a box cover 802 sealed and connected to an opening of the box body 801, which facilitates the mounting of the magnetic induction generator 2.

Of course, in other embodiments, in addition to use the sealing box 800, the power generation induction coil 23 of the magnetic induction generator 2 may also be sealed and then fixed to the filter 700 or the mounting base 600 by directly perfusing an insulating material such as epoxy resin.

The pump housing 500 includes a pump housing body 501 and a pump housing cover 502 that are detachably connected to each other. The pump housing cover 502 is provided with a water inlet 503, a side wall of the pump housing body 501 away from the pump housing cover 502 is provided with a through hole. The first rotating shaft 122 passes through the through hole from a side of the mounting base 600 to be connected to the impeller 13 in the pump housing body 501. An upper end of the pump housing 500 is provided with a water outlet 504 communicated with a drain pipe. The drain pipe is disposed in the filter 700.

Furthermore, the aquarium in this embodiment further includes a base 900. The stator 11 is fixed to the base 900. The tank 400 is detachably mounted on the base 900. Mounting the tank 400 on the base 900 can enable the first permanent magnet rotor 121 to be mounted between the two iron core protrusion portions of the stator 11, which facilitates the disassembling or assembling.

In this embodiment, the base 900 is recessed to define a stator isolation chamber 901 that faces toward the tank 400. The stator isolation chamber 901 has the same structure and size as those of the stator 11. The stator 11 is disposed in the stator isolation chamber 901 and secured to the base 900 by epoxy resin injection molding.

Specifically, the stator receiving chamber 410 further includes a second receiving chamber 412 configured for receiving the coil winding 112. The first receiving chamber 411 is communicated with the second receiving chamber 412. An outer wall of the stator isolation chamber 90 is inserted and fitted with the stator receiving chamber 410.

A wire slot is further provided on the base 900. The bottom of the base 900 is provided with a wire securing clip 902 connected to the wire slot for securing a wire that is led out of the base 900 and that is coupled to the coil winding 112 of the stator 11.

In this embodiment, the aquarium further includes a tank cover which is detachably mounted on an upper end of the tank 400.

In this embodiment, the aquarium further includes a drive circuit for providing a low-voltage direct current power source and a voltage change and controlling turning on and off of the electric device.

In this embodiment, the second lamp 701 is disposed on the upper end of the filter 700, where there is further provided with a button for controlling the switching on and off of the second lamp 701. The second lamp 701 may be a light emitting diode (LED) lamp, which is disposed on the upper end of the filter 700 and is operative to adjust the brightness as well as the lighting colors of the LED lamp by the drive circuit.

Apparently, the above embodiments of the present disclosure are merely illustrative of the present disclosure and are not intended to limit the implementations of the present disclosure. For those having ordinary skill in the art, alterations or modifications in other different forms can be made based on the above description. Implementations of the present disclosure cannot be and toned not be exhausted herein. Any modifications, equivalent substitutions and improvements made without departing from the spirit and principle of the present disclosure shall all fall in the scope of the claims of the present disclosure.

What is claimed is:

1. A power generation apparatus, comprising a water pump and a magnetic induction generator;
wherein the water pump comprises a stator, a first rotor assembly, and an impeller connected to the first rotor assembly, the first rotor assembly comprising a first permanent magnet rotor and a first rotating shaft disposed at an axis of the first permanent magnet rotor, the first permanent magnet rotor being disposed adjacent to the stator; and
wherein the magnetic induction generator is disposed adjacent to the stator or to the first permanent magnet rotor and is operative to be coupled to an electric device, wherein the stator comprises a coil winding operative to be coupled to an external power source, and when the coil winding is coupled to an input alternating current the first permanent magnet rotor is configured to rotate enabling the magnetic induction generator to generate an induced current to power up the electric device.

2. The power generation apparatus according to claim 1, wherein the magnetic induction generator comprises a second rotor assembly and a power generation induction coil;
wherein the second rotor assembly comprises a second permanent magnet rotor and a second rotating shaft disposed at an axis of the second permanent magnet rotor, the power generation induction coil is wound around an exterior of the second permanent magnet rotor, and when the coil winding is coupled to the input alternating current the second permanent magnet rotor is operative to rotate relative to the power generation induction coil.

3. The power generation apparatus according to claim 1, wherein an axis of the second rotating shaft and an axis of the first rotating shaft forms an included angle that lies in the range of 0° to 15°.

4. The power generation apparatus according to claim 2, wherein the magnetic induction generator further comprises a reel disposed outside the second permanent magnet rotor, the second permanent magnet rotor being clearance-fitted to the reel, the power generation induction coil being wound around on the reel along the axis of the second permanent magnet rotor, wherein both ends of the reel that reside along a length thereof are each provided with a rotating shaft seat, and the second rotating shaft passes through the reel to be connected to the rotating shaft seats.

5. The power generation apparatus according to claim 1, wherein the water pump further comprises a housing, wherein the stator, the first rotor assembly, and the impeller are all arranged in the housing.

6. The power generation apparatus according to claim 4, wherein the water pump further comprises a housing, wherein the stator, the first rotor assembly, and the impeller are all arranged in the housing.

7. The power generation apparatus according to claim 6, wherein the housing defines a mounting slot at a location adjacent to the first permanent magnet rotor, and the magnetic induction generator is detachably mounted in the first mounting slot.

8. The power generation apparatus according to claim 7, further comprising a mounting box in which the magnetic induction generator is detachably mounted, wherein the mounting box is detachably mounted in the first mounting slot, and the power generation induction coil comprises a lead wire that passes through the mounting box to be coupled to the electric device.

9. The power generation apparatus according to claim 8, wherein the mounting box comprises a box body having an open end and a cover body and configured to cover the open end, a positioning step is provided on an inner wall of the box body that directly faces the open end, a plurality of positioning columns are provided at intervals on a side of the cover body adjacent to the box body, and when the cover body covers the open end, both sides of the reel abut against the positioning step and the plurality of positioning columns, respectively.

10. The power generation apparatus according to claim 9, wherein the box body is provided with a mounting hole located adjacent to the open end and an admission hole in communication with the mounting hole, the admission hole having a smaller size than that of the mounting hole,
wherein the positioning step is formed between the admission hole and the mounting hole; and the cover body is provided with at least two of the positioning columns disposed at intervals, and an admission area is formed between the two positioning columns, wherein the magnetic induction generator is mounted in the mounting hole, one end of the second rotating shaft extends into the admission hole, and the other end extends into the admission area.

11. The power generation apparatus according to claim 5, wherein the electric device comprises a first lamp disposed outside the housing adjacent to the magnetic induction generator.

12. An aquarium equipment, comprising a power generation apparatus, the power generation apparatus comprising a water pump and a magnetic induction generator;
wherein the water pump comprises a stator, a first rotor assembly, and an impeller connected to the first rotor assembly, the first rotor assembly comprising a first permanent magnet rotor and a first rotating shaft disposed at an axis of the first permanent magnet rotor, the first permanent magnet rotor being disposed adjacent to the stator; and
wherein the magnetic induction generator is disposed adjacent to the stator or to the first permanent magnet rotor and is operative to be coupled to an electric device, wherein the stator comprises a coil winding operative to be coupled to an external power source, and when the coil winding is coupled to an input alternating current the first permanent magnet rotor is configured to rotate enabling the magnetic induction generator to generate an induced current to power up the electric device.

13. The aquarium equipment according to claim 12, wherein the aquarium equipment is an aquarium wherein the water pump further comprises a pump housing, and the impeller is mounted in the pump housing;
wherein the first rotor assembly, the pump housing, and the impeller are mounted in a tank of the aquarium, and the stator is mounted outside the tank; and
a U-shaped iron core of the stator comprises two iron core protrusion portions that protrude out of the coil winding of the stator, an outer wall of the tank is recessed to define a stator receiving chamber that faces towards the tank, which comprises two first receiving chambers spaced apart from each other, the iron core protrusion portions are disposed in the first receiving chambers, a receiving slot is defined in an inner wall of the tank and between the two first receiving chambers, the impeller is fixedly connected to the first permanent magnet rotor in the receiving slot by the first rotating shaft, and the magnetic induction generator is disposed inside the tank adjacent to the stator or the first permanent magnet rotor.

14. The aquarium equipment according to claim 13, wherein the electric device comprises a second lamp, a filter is detachably mounted in the tank and disposed at a bottom of the tank, the second lamp is mounted on the filter, the pump housing is detachably fixed to a lower end of the filter, and the stator receiving chamber is located at the bottom of the tank.

15. The aquarium equipment according to claim 14, wherein the water pump further comprises a mounting base connected to the pump housing, is the mounting base being disposed in the receiving slot, the first rotor assembly is mounted in mounting base, the magnetic induction generator is mounted in a sealing box, which is disposed at a side of the mounting base adjacent to the filter, a bottom of the filter is recessed to define a second mounting slot that faces towards the filter, and the sealing box and the pump housing are inserted and fixed to the second mounting slot.

16. The aquarium equipment according to claim 15, wherein the pump housing comprises a pump housing body and a pump housing cover detachably connected to each other, the pump housing cover defines a water inlet, a side wall of the pump housing body away from the pump housing cover defines a through hole, the first rotating shaft passes through the through hole from the side of the mounting base to be connected to the impeller in the pump housing body, and an upper end of the pump housing is provided with a water outlet communicated to a drain pipe.

17. The aquarium equipment according to claim 13, further comprising a base, wherein the stator is fixed to the base, and the tank is detachably mounted on the base.

18. The aquarium equipment according to claim 13, further comprising a drive circuit configured to provide a low-voltage direct current power source, a voltage change, and to control turning on and off of the electric device.
